(19) United States
(12) Patent Application Publication
(10) Pub. No.: US 2016/0073699 A1
(43) Pub. Date: Mar. 17, 2016

(54) STYLISH ARTICLES OF CLOTHING

(71) Applicant: David Drapela, Austin, TX (US)

(72) Inventor: David Drapela, Austin, TX (US)

(21) Appl. No.: 14/853,968

(22) Filed: Sep. 14, 2015

Related U.S. Application Data
(60) Provisional application No. 62/049,690, filed on Sep. 12, 2014.

(51) Int. Cl. A41D 1/00; H04W 4/12; G06F 3/03; A41D 27/08; A41D 1/06

(52) U.S. Cl. CPC A41D 1/002; A41D 27/085; A41D 1/06; G06F 3/03; H04W 4/12

(57) ABSTRACT

Embodiments provide fashionable articles of women's clothing incorporating electronic components.

### CROSS-REFERENCE TO RELATED APPLICATIONS

This application claims priority to Nonprovisonal Patent Application No. 62/049,690, filed Sep. 12, 2014, which is hereby incorporated by reference in its entirety.

### FIELD OF THE INVENTION

The disclosure relates to stylish clothing, more specifically clothing comprising stylish openings on specific areas of a piece of clothing. Furthermore, the disclosure may further relate to clothing incorporating conductive fibers and electronic components.

### BACKGROUND OF THE INVENTION

The present disclosure is directed to the field of women's wear, and in particular to early teen to early twenties women's clothing incorporating fashionable features providing points of interest for the user and onlookers.

The present disclosure represents a significant divergence between the current disclosure and previous types and styles of women's garments by providing interactive (and in some forms) interchangeable points of interest as well as allowing the exhibition of a small portion of the various styles of decorative undergarments that can be worn in conjunction with the disclosure.

Accordingly, it is a principal object of the current disclosure to provide semi-promiscuous openings on articles of clothing. It is a further objective to provide conductive fibers and electronic components on and within articles of clothing.

### BRIEF SUMMARY OF THE INVENTION

The disclosure at hand provides novelty articles of clothing for young women that, while having the basic women's clothing construction, incorporate a variety of interesting and attractive features enabling the user, while wearing the article of clothing, to have multiple points of interest derived from special features incorporated within the article of clothing.

In one preferred embodiment of the current disclosure, sometimes herein referred to as “door jeans”, one or both of the legs of a pair of jeans may be provided with an opening positioned at various locations provided with a door flap that can be secured at one side that when opened, may reveal the user's skin. The outer side of the door may be screen printed with a question, while the inner side may have an answer that on some versions of the disclosure may be interchangeable by means of a hook and loop fastener such as Velcro® (a registered trademark of Velcro® Industries B.V.) or some other fastening device.

In a variation of the “door pocket” jeans, the opening may be spanned with various designs of decorative lace as opposed to revealing the user's skin. Some versions of the disclosure may allow for the decorative lace to be removable as well as interchangeable. Each door pocket's initial state may be closed with Velcro or some other fastening device, such as magnets, zippers, etc.

In another embodiment of the “door pocket” jeans, there may be two openings slightly below the waistband of the jeans and above the edge of the front pocket that are designed to develop interest by revealing the user's skin or in particular whatever type of decorative undergarment they may be wearing at the time. In a variation of the disclosure, the openings may be spanned with various designs of decorative lace as opposed to revealing the user's skin. Some versions of the disclosure may allow for the decorative lace to be removable and interchangeable.

In another embodiment, the jeans may incorporate electronic components. In an application on a user electronic device, an individual may create a message. The message may be sent to a processor incorporated within the jeans. Commands may be sent to a display found on the jeans to display the message. In embodiments, the display may be located within a door element that may “hinge” and open when an individual engages the door element.

The disclosure may further provide a method. The method may comprise typing, on a keyboard of a user interface of a user electronic device, a message. Method may further comprise simultaneously saving the message as data on a memory of the user electronic device and sending, via a wireless network, the message data to a processor affixed to a pair of jeans. In embodiments, the jeans may further comprise at least one enageable jean flap and at least one message element backing.

Method may further comprise sending, via the processor, instructions to a display affixed to the message element backing to display the message sent from the user electronic device. Method may further comprise displaying, via the display, the message.

Some of the features generally described above can be mixed and matched, as can be appreciated. For a more complete understanding of the above and other features and advantages of the invention, reference should be made to the following detailed description of preferred embodiments of the invention, and to the accompanying drawing.

These and other aspects of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages here provided will become apparent to one with skill in the art upon examination of the accompanying FIG.S and detailed description. It is intended that all such additional systems, methods, features and advantages that are included within this description, be within the scope of any claims filed now or later.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 depicts a computing system and related peripherals that may operate with a pair of jeans incorporated with electronic components in accordance with embodiments.

FIG. 2 depicts a front view of a pair of women's jeans with jean flaps and openings in accordance with embodiments.

FIG. 3 depicts a back view of a pair of women's jeans with jean flaps incorporated on the upper and lower parts of the legs of the jeans in accordance with embodiments.

FIG. 4 depicts the jean flap with a supporting means placed between an edge of the jean flap and the denim of the jeans in accordance with embodiments.

FIG. 5 depicts an incorporation of Velcro® fasteners for a variation of the jean flap that allows saying panels to be attached to the inside or outside of the jean flap in accordance with embodiments.

FIG. 6 depicts a pair of women's jeans with openings that are in a shape that contours upward to accentuate the feminine shape and reveal the user's skin and/or decorative undergarments in accordance with embodiments.

FIG. 7 depicts a pair of women's jeans with openings that are in an arched shape to accentuate the feminine shape and reveal the user's skin and/or decorative undergarments in accordance with embodiments.

FIG. 8 depicts a rear depiction of a pair of women's jeans with door elements in accordance with embodiments.

FIG. 9 depicts a front depiction of a pair of women's jeans with door elements in accordance with embodiments.

FIG. 10A depicts a door element with three stitched sides in accordance with embodiments.

FIG. 10B depicts a door element with one stitched side in accordance with embodiments.

FIG. 11 depicts an interior view of a door element with one stitched side in accordance with embodiments.

FIGS. 12A and 12B depict a front and back of a message tab in accordance with embodiments.

FIG. 13 depicts a box diagram of the components of a pair of jeans incorporated with electronic components in accordance with embodiments.

FIG. 14 displays a method of displaying a message in accordance with embodiments.

### DETAILED DESCRIPTION OF ILLUSTRATIVE EMBODIMENTS

Reference now should be made to the drawings, in which the same reference numbers are used throughout the different FIG.s to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

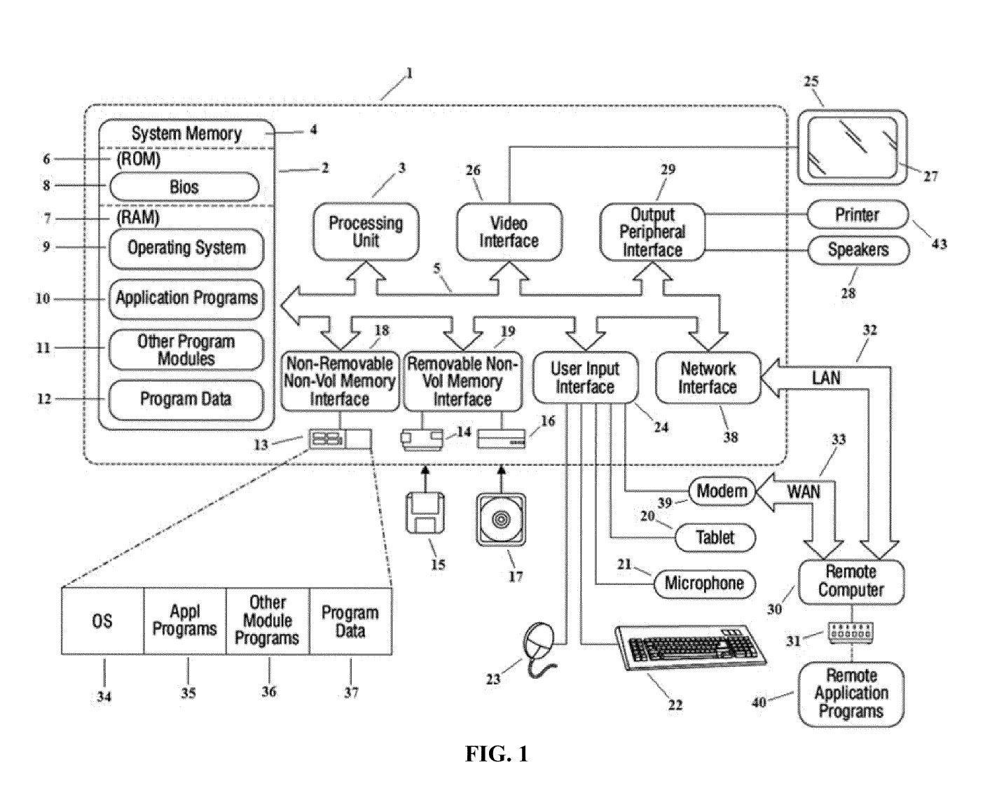

FIG. 1 depicts a computing system and related peripherals that may operate with a pair of jeans incorporated with electronic components in accordance with embodiments.

With reference to FIG. 1, an exemplary system within a computing environment for implementing the disclosure includes a general purpose computing device in the form of a computing system 1, commercially available from, for example, Intel, IBM, AMD, Motorola, Cyrix, etc. Components of the computing system 2 may include, but are not limited to, a processing unit 3, a system memory 4, and a system bus 5 that couples various system components including the system memory 4 to the processing unit 3. The system bus 5 may be any of several types of bus structures including a memory bus or memory controller, a peripheral bus, or a local bus using any of a variety of bus architectures.

Computing system 1 typically includes a variety of computer readable media. Computer readable media can be any available media that can be accessed by the computing system 1 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 1.

The system memory 4 includes computer storage media in the form of volatile and/or nonvolatile memory such as read only memory (ROM) 6 and random access memory (RAM) 7. A basic input/output system 8 (BIOS) 8, containing the basic routines that help to transfer information between elements within computing system 1, such as during start-up, is typically stored in ROM 6. RAM 7 typically contains data and/or program modules that are immediately accessible to and/or presently being operated on by processing unit 3. By way of example, and not limitation, an operating system 9, application programs 10, other program modules 11, and program data 12 are shown.

Computing system 1 may also include other removable/non-removable, volatile/nonvolatile computer storage media. By way of example only, a hard disk drive 13 that reads from or writes to non-removable, nonvolatile magnetic media, a magnetic disk drive 14 that reads from or writes to a removable, nonvolatile magnetic disk 15, and an optical disk drive 16 that reads from or writes to a removable, nonvolatile optical disk 17 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 13 is typically connected to the system bus 5 through a non-removable memory interface such as interface 18, and magnetic disk drive 14 and optical disk drive 16 are typically connected to the system bus 5 by a removable memory interface, such as interface 19.

The drives and their associated computer storage media, discussed above, provide storage of computer readable instructions, data structures, program modules and other data for the computing system 1. For example, hard disk drive 13 is illustrated as storing operating system 34, application programs 35, other program modules 36, and program data 37. Note that these components can either be the same as or different from operating system 9, application programs 10, other program modules 11, and program data 12. Operating system 34, application programs 35, other program modules 36, and program data 37 are given different numbers here to illustrate that, at a minimum, they are different copies.

A user may enter commands and information into the computing system 1 through input devices such as a tablet, or electronic digitizer, 20, a microphone 21, a keyboard 22, and pointing device 23, commonly referred to as a mouse, trackball, or touch pad. These and other input devices are often connected to the processing unit 3 through a user input interface 24 that is coupled to the system bus 5, but may be connected by other interface and bus structures, such as a parallel port, game port or a universal serial bus (USB).

A monitor 25 or other type of display device is also connected to the system bus 5 via an interface, such as a video interface 26. The monitor 25 may also be integrated with a touch-screen panel 27 or the like. Note that the monitor and/or touch screen panel can be physically coupled to a housing in which the computing system 1 is incorporated, such as in a tablet-type personal computer. In addition, computers such as the computing system 1 may also include other peripheral output devices such as speakers 28 and printer 43, which may be connected through an output peripheral interface 29 or the like.

Computing system 1 may operate in a networked environment using logical connections to one or more remote computers, such as a remote computing system 30. The remote computing system 30 may be a personal computer (including, but not limited to, mobile electronic devices), a server, a router, a network PC, a peer device or other common network node, and typically includes many or all of the elements described above relative to the computing system 1, although only a memory storage device 31 has been illustrated. The logical connections depicted include a local area network (LAN) 32 connecting through network interface 38 and a wide area network (WAN) 33 connecting via modem 39, but may also include other networks. Such networking environments are commonplace in offices, enterprise-wide computer networks, intranets, and the Internet.

For example, in the present embodiment, the computer system 1 may comprise the source machine from which data is being generated/transmitted and the remote computing system 30 may comprise the destination machine. Note however that source and destination machines need not be connected by a network or any other means, but instead, data may be transferred via any media capable of being written by the source platform and read by the destination platform or platforms.

In another example, in the present embodiment, the remote computing system 30 may comprise the source machine from which data is being generated/transmitted and the computer system 1 may comprise the destination machine.

In a further embodiment, in the present disclosure, the computing system 1 may comprise both a source machine from which data is being generated/transmitted and a destination machine and the remote computing system 30 may also comprise both a source machine from which data is being generated/transmitted and a destination machine.

For Referring to FIG. 1, for the purposes of this disclosure, it is will be appreciated that the remote computer 30 may include any suitable terms such as, but not limited to “device”, “processor based mobile device”, “mobile device”, “electronic device”, “processor based mobile electronic device”, “mobile electronic device”, “wireless electronic device”, and or “location-capable wireless device,” may be synonymous with remote computer 30 including a smart phone or tablet computer.

The central processor operating pursuant to operating system software such as, but not limited to Apple IOS®, Google Android® IBM OS/2®, Linux®, UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generations. The provided functionality may be embodied directly in hardware, in a software module executed by a processor, or in any combination of the two.

Furthermore, software operations may be executed, in part or wholly, by one or more servers or a client's system, via hardware, software module, or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

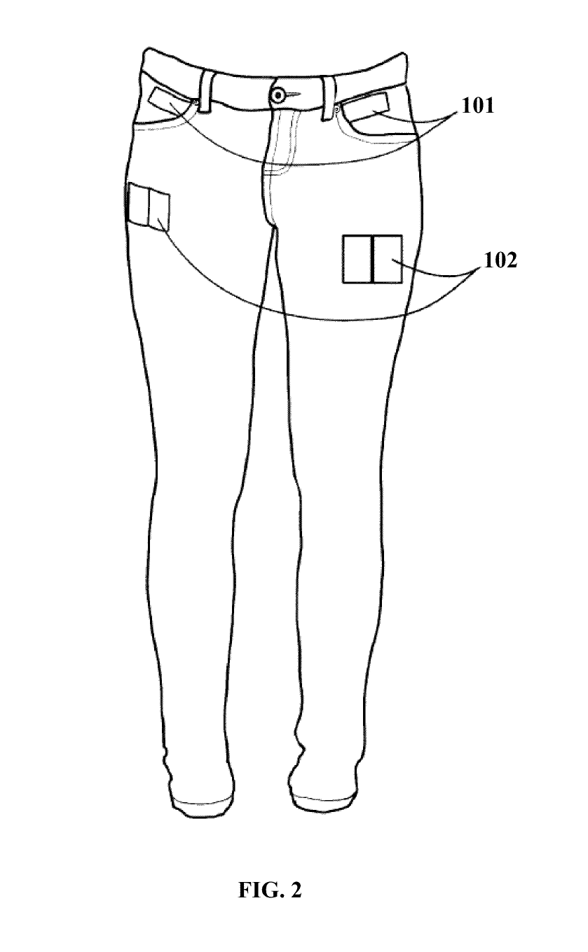

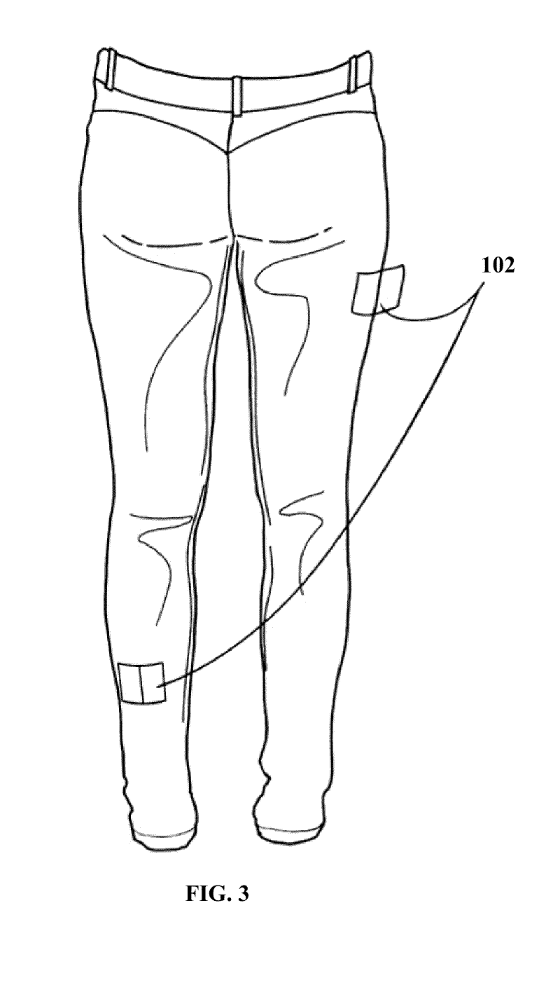

FIG. 2 depicts a front view of a pair of stylistic jeans with jean flaps 102 and openings 101 in accordance with one embodiment. The jean flap may be cut out of either the tubular body portion of the jeans on three sides or out of one of the tubular legs of the jeans on three sides, with the fourth side acting as a connection means to either the main body of the jeans or one of the tubular legs of the jeans. In a preferred embodiment, the jean flap 102 may be of a rectangular shape. In certain embodiments, one or both of the tubular legs of the jeans may be provided with a jean flap 101 positioned at various locations provided with a flap that can be secured at one side that when opened, may reveal the user's skin. For example, FIG. 3 depicts more than one jean flap 102 located on the back of a pair of stylistic jeans. The back of a pair of jeans may also comprise one or more openings 101 (not shown). In further embodiments, the jean flap 102 may be of a shape other than a rectangle.

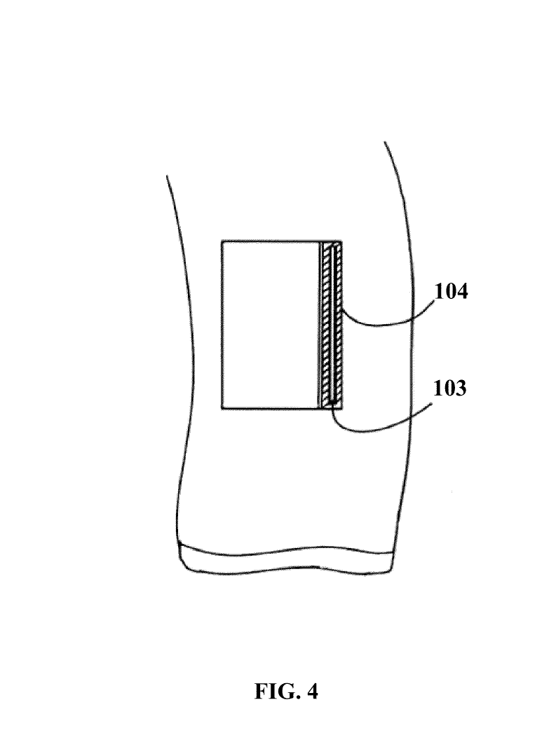

FIG. 4 depicts the jean flap 102 with a supporting means 103 placed between an edge of the jean flap 102 and an edge of the denim of the jeans. The edge of the jean flap 102 and an edge of the denim of the jeans are both represented by the diagonally shaded area 104 found in FIG. 4 and emphasizes that the supporting means 103 is found in between the two edges. Further examples of a supporting means 103 are presented in the following paragraph.

The supporting means 103 may allow the jean flap 102 to “close” just as a door may be closed on a house. In a further embodiment, the supporting means 103 may be magnets. For proper functionality, the magnets may be placed either internally or externally on both the jean flap and the main body of the jeans. Placed “internally” may refer to the magnets being held within a fold of fabric that is sewn together. This may be carried out in one of two ways: folding over and sewing extra fabric over the magnets or sewing extra fabric over the magnets. If placed externally, the magnets may be held onto the fabric using an adhesive material. Another example of a supporting means 103 includes Velcro®. Another example of a supporting means 103 includes zippers. The above supporting means 103 examples are in no way limiting. The supporting means 103 may comprise other means other than the above mentioned means. In further embodiments, more than one edge of the jean flap may comprise a supporting means 103 that may affix the flap to the jeans. In other embodiments, the jean flap may only be affixed to a pair of jeans by way of the supporting means 103 and may be completely removable from the pair of jeans.

In a further embodiment, the jean flap may include interior reinforcement that may provide integrity to the jean flap. The interior reinforcement may be sewn between the jean flap and another piece of fabric so the interior reinforcement is fully encompassed in fabric. The interior fabric must be stiff but also have a high enough melting point to avoid melting when the jeans are cleaned. Examples of materials that may be used for the interior reinforcement may include, but is not limited to, thermoplastic, thermoset plastic, elastomer, metal, ceramic, silicone, composite, etc., or combinations thereof. If the reinforcement is a thermoplastic, the jean flap may be formed or “molded” into a desired geometry if the glass transition temperature of the thermoplastic is low enough. An example of a thermoplastic that may be molded into a specific geometry for the above purpose is polyethylene terephthalate (PET). In a further embodiment, the interior reinforcement may comprise the use of Pellon® (a registered trademark of Freudenberg Nonwovens Limited Partnership) extra-firm stabilizer.

In another embodiment, openings may exist that may be located in the vicinity of the pocket area of a pair of jeans and may preferably have a geometry of elongated rectangles. The openings may add promiscuity to an interaction between a wearer of the jeans and another person by allowing only a small part of skin or a small part of skin and undergarments to be visible.

In further embodiments, one or more accents may be added to jean flaps and openings in accordance with one embodiment. The accent(s) include lines of fabric that cross the threshold of the openings or uncovered area when a jean flap is open. The lines of fabric may be one color or multiple colors and may be removable or non-removable from the jeans. The lines of fabric may also be any suitable thickness. Another example of an accent includes one or more “window grids”. So, to appear more aesthetically pleasing, the jean flap may comprise the window grid. This gives an onlooker a feeling that they are actually looking into a window located on the pants. When cut correctly, the jean flaps may be “opened” and “closed” just as a real window may be opened or closed. When open, the jean flap may expose a wearer's skin. This may provide promiscuity to an onlooker that happens to notice the jean flap. Other types of accents may include, but are not limited to rhinestones, glitter, fringed material, etc. Furthermore, the jean flap may comprise additional fabric with different color, structure, and/or composition than the jean flap.

Additional accents may include sayings that appear on the inner and outer side of the jean flap. For example, the outer side of the jean flap may be screen printed with a question, while the inner side may have an answer that on some versions of the disclosure may be interchangeable by means of Velcro® or some other fastening device. In different embodiments, the sayings on the outer side of the jean flap may be removable by similar or different means than the sayings on the inner side of the jean flap.

The following are a list of example sayings that may be used on the jeans: “Want In?”, “Please Knock”, “Saddle Up”, “Let's Ride”, “Magic Door”, “Closed for Business”, “A/C Vent”, “Whoa!!”, “Secret Passage”, “Hi There”, “Want to See?”, “Want Inside?”, “Dinner Time”, “Breakfast Time”, “Ask Me”, “Hello”, “Don't Try”, “Snack Time”, “Not Now”, “8 PM Showing”, “(Picture of Happy Face) Hi!!”, “I Feel You”, “Go Slower”, “I Surrender”, “Diamond Mine”, “Want a Gem?”, “Open Slowly”, “Let's Ride”, “Look-See?”, “Space Cadet”, “Open Range”, “Grass Fed”, “Non Taxable”, “Smoking Hot”, “Careful”, “Come In”, “Not Now”, “Liquid Inside”, “Home Coming”, “Practice Field”, “Work Out Room”, “Golden Door”, “Hot Dog Wanted”, “Anything Goes”, “Warm Buns”, “Don't Touch”, “Butt What?”, “Warm Inside”, “Boarder Town”, “Open Door Policy”, “Like It?”, “Come On”, “Feels Good”, “Vanilla Flavor”, “Angel Food”, “Drop In”, “BEAUTIFUL INSIDE”, “CASH ONLY”, “NO CREDIT”, “STING ME”, “NO WAY”, “FUN TRAP”, “LICKER LICENSE”, “BREATH TEST”, “ORGANIC”, “FARM RAISED”, “BID ON IT”, “WANT SOME?”, “LOOK IN?”, “YOU LIKE?”, “LICKING GOOD”, “SHOW TIME”, “DON′T FINGER”, “HOT STUFF”, “LOVING INSIDE”, “SWEET THING”, “WANT ACTION?”, “CLASS ACTION”, “TRUST ME”, “RING ME”, “IT′S RIPE”, “OVER DONE”, “ON FIRE”, “BUTTERFLY TIME”, “PLAY TIME 3 TO 4”, “BEACH TIME”, “CAN'T WAIT”, “YOU READY?”, “(FLOWER OPENING)”, “FULL BLOOM”, “NEED WATERING”, “HUNGRY?”, “SCREEN SHOT”, “BAR-B-Q INSIDE”, “SUCKER?”, “WATER HOLE”, “WONDERING?”, “OPEN IT!”, “SURPRISE INSIDE”, “CRACKER JACK BOX”, and “COFFEE SHOP.” It is noted that questions and/or answers may include words as well as pictures. In further embodiments, the letters of the words in each question/answer may be capitalized or not capitalized.

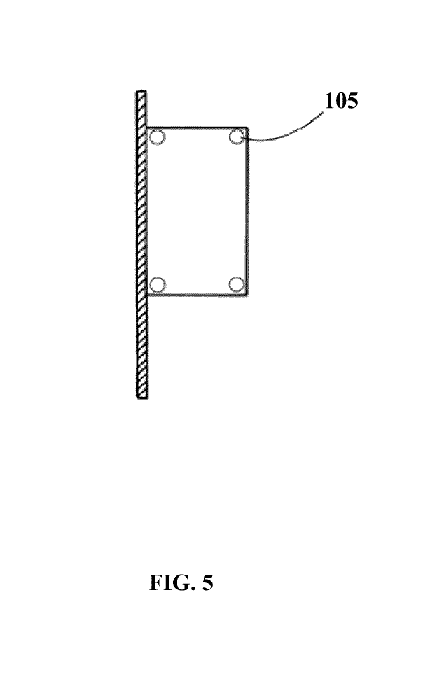

In a further embodiment, the sayings may be located on a panel that may be attached to an exterior panel or an interior panel of the engageable jean flap using Velcro® or another attaching means. FIG. 5 depicts an incorporation of Velcro® fasteners for a variation of the jean flap 102 that allows saying panels to be attached to the inside or outside of the jean flap 102. When Velcro® is utilized, the engageable jean flap 102 may comprise one or more first halves of a Velcro® patch 105 and the panel may comprise one or more second halves of a Velcro® patch (not depicted) so that the jean flap 102 and the panel may be secured together when the first and second halves are placed together.

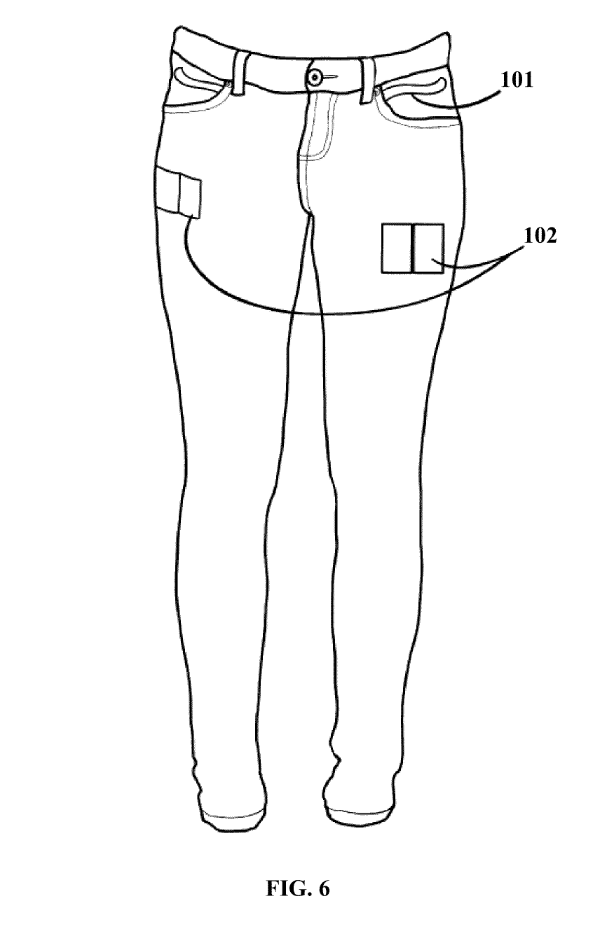

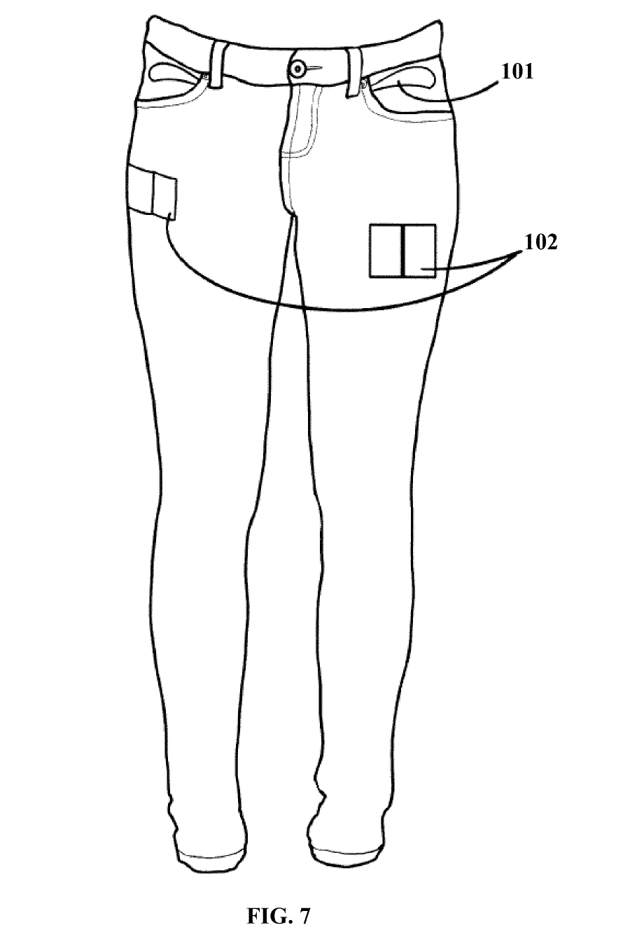

In a further embodiment, the openings on the jeans may take the shape of a shape other than a rectangle such as, but not limited to squares, triangles, circles, trapezoids, etc. An example is shown in FIG. 6, which depicts openings 101 that are in a shape that contours upward to accentuate the feminine shape and reveal the user's skin and/or decorative undergarments. A further example is shown in FIG. 7, which depicts openings 101 that are in an arched shape to accentuate the feminine shape and reveal the user's skin and/or decorative undergarments.

In a further embodiment, the jeans may comprise a phone sized pocket on the side of the jeans (not the front or the back as shown in FIG. 2 and FIG. 3). This pocket may allow a user of the jeans to place their cell phone in the pocket, which may provide a more comfortable wearing experience as opposed to having the cell phone being placed in a front or back pocket.

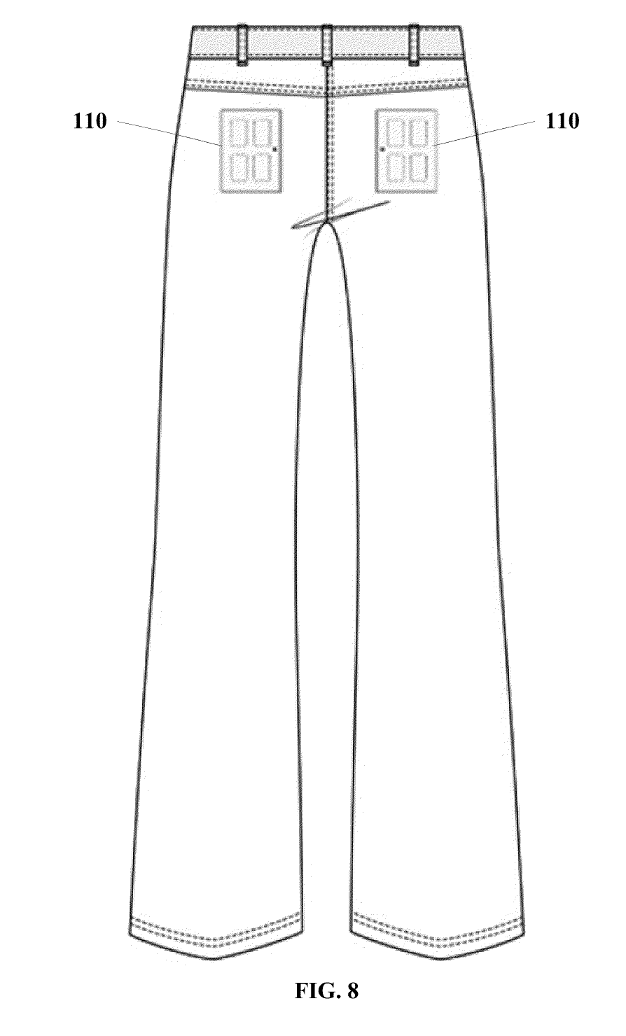

FIG. 8 depicts a rear depiction of a pair of women's jeans with door elements 110 in accordance with embodiments. One or more door elements 110 may be affixed to one or more front portions of a pair of women's jeans. In the depiction, door elements 110 may exist on portions of the jeans typically where pockets may exist. In embodiments, the door elements 110 may be affixed to pockets that exist on the jeans.

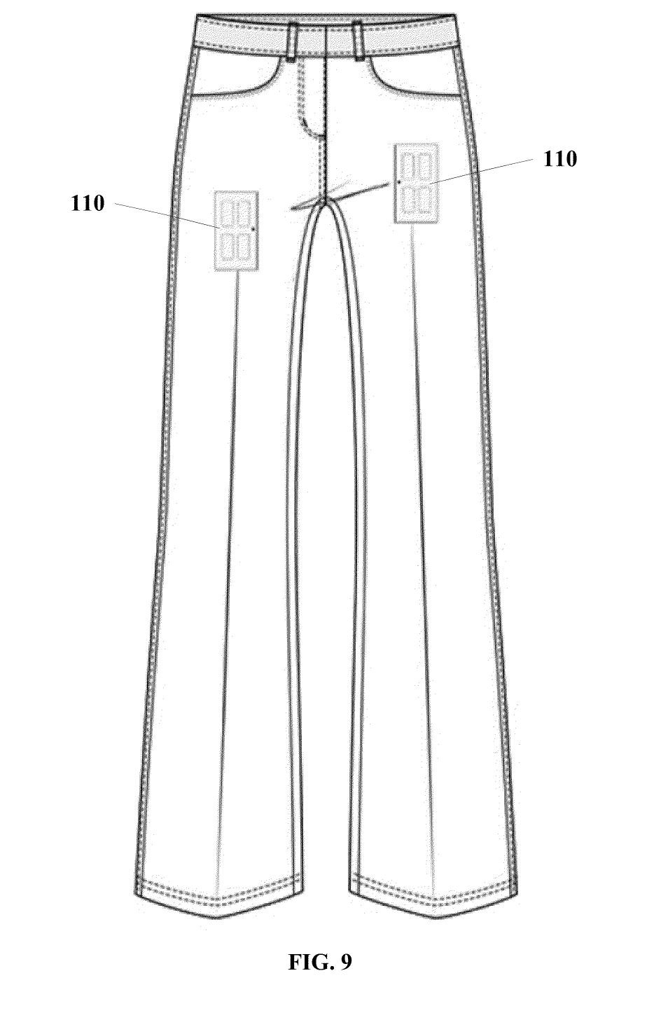

FIG. 9 depicts a front depiction of a pair of women's jeans with door elements 110 in accordance with embodiments. One or more door elements 110 may be affixed to one or more front portions of a pair of women's jeans. In embodiments, back portions may refer to portions of the jeans that are located on the opposite side of the side of the jeans with a fly portion. In embodiments, front portions may refer to portions of the jeans that are located on the same side of the side of the jeans with a fly portion. It is noted that the front portions of the jeans and the back portions of the jeans may be delineated with stitches running down the exterior sides of the jeans and stitches running down the interior sides of the jeans (both interior sides and exterior sides perpendicular to the crotch line of the jeans). In embodiments, door elements 110 that are not a pocket or that are not affixed to a pocket may be larger or smaller in size.

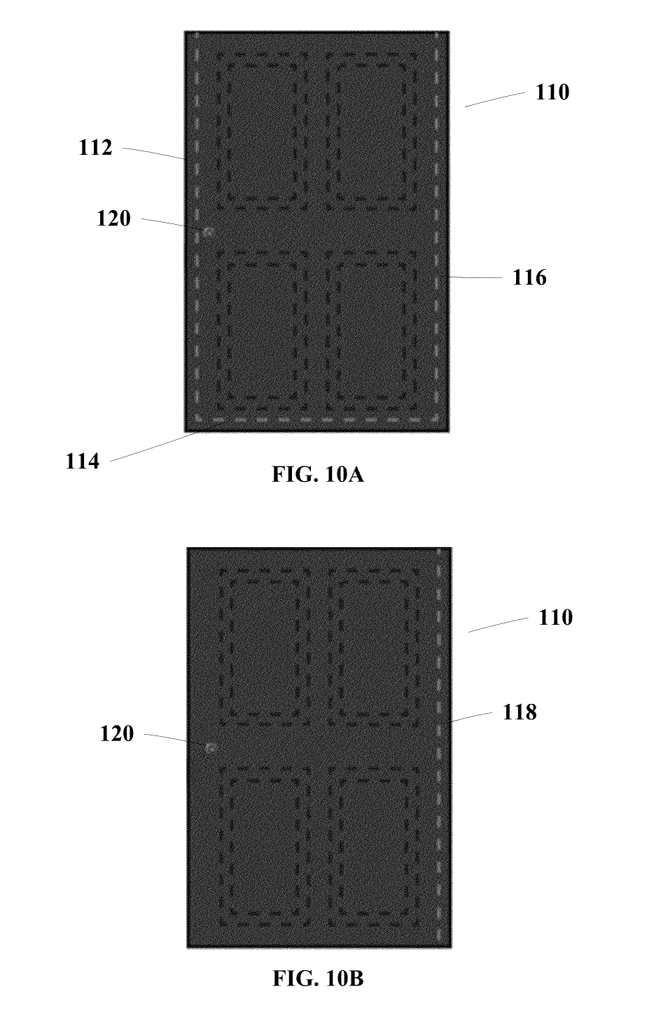

FIG. 10A depicts a door element 110 with three stitched sides 112,114,116 in accordance with embodiments. The door element 110 may comprise stitching on the left, right, and bottom sides. This may allow, in embodiments, for the door element 110 to act as a pocket when the unstitched side is facing upward when the door element is stitched to a pair of jeans. FIG. 10B depicts a door element 110 with one stitched side 118 in accordance with embodiments. The door element 110 may comprise stitching 118 on a single left or right side. This may allow, in embodiments, for the door element 110 to be able to freely “hinge” about the stitched side 118 and away from the jeans. In embodiments, a brass metal rivet 120 may be affixed to a portion of the door element 110 in order to represent a door knob. In embodiments, the brass metal rivet 120 may be a 12 ligne brass metal rivet.

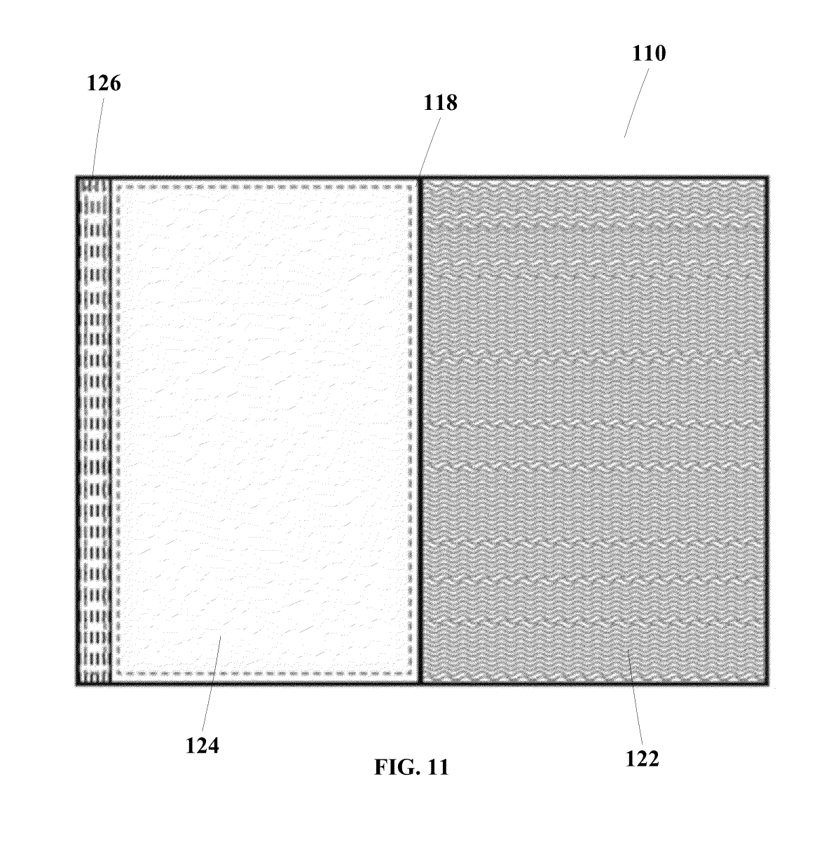

FIG. 11 depicts an interior view of a door element 110 with one stitched side 118 in accordance with embodiments. The door element 110 may comprise an exterior surface and an interior surface. The door element may be stitched on one side to the jeans as well as to a Velcro loop layer 122 affixed to the jeans located between the door element 110 and the jeans. The Velcro loop layer 122 may be affixed to the jeans via stitching running around the periphery of the Velcro loop layer 122. A first portion of the interior surface may comprise an organza backing 124. A second portion may comprise a Velcro hook layer 126 that may affix to the Velcro loop layer 122 when the door element 110 is pressed to the Velcro loop layer 122. In embodiments, the stitching found on the door element 110 and/or the Velcro loop layer 122 may match the color of one or more of the organza backing 124, the Velcro loops, and the Velcro hooks. In embodiments, the Velcro loop layer 122 may alternatively be referred to as a base layer or a message element backing and may also comprise elements other than Velcro loops such as, but not limited to rivets, magnets, and zippers.

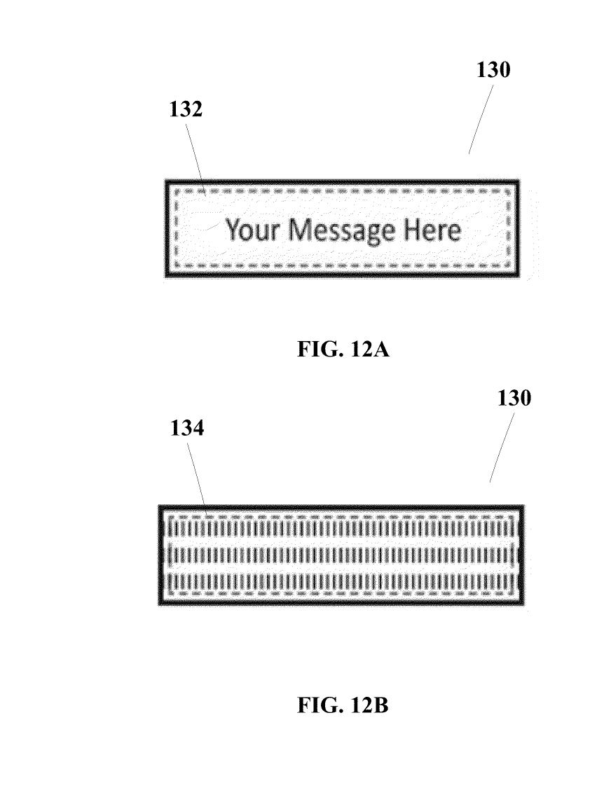

FIGS. 12A and 12B depict a front and back of a message tab 130 in accordance with embodiments. The message tab 130 may comprise a front message portion 132 and a back Velcro hook portion 134. The front message portion 132 may comprise a permanent message or a temporary message. A permanent message may comprise a set of words that may be stitched, screen printed, etc. on the front message portion. A temporary message may comprise a set of words that may be written by an individual on the front message portion 132. In embodiments, the front message portion 132 may comprise dry erase board that may be written on using a dry erase marker. The front message portion 132 may be affixed to the back Velcro hook portion 134 via stitching. In embodiments, the stitching may be the same color as the Velcro hooks on the back Velcro hook portion 134. The back Velcro hook portion 134 of one or more message tabs 130 may be affixed to the Velcro loop layer 122. This may allow for an individual to view the one or more message tabs 130 by peeling the door element 110 from the Velcro loop layer 122 in order to reveal the one or more message tabs 130. In embodiments, the permanent message or temporary message may comprise sayings that have been previously mentioned in Paragraph [0026].

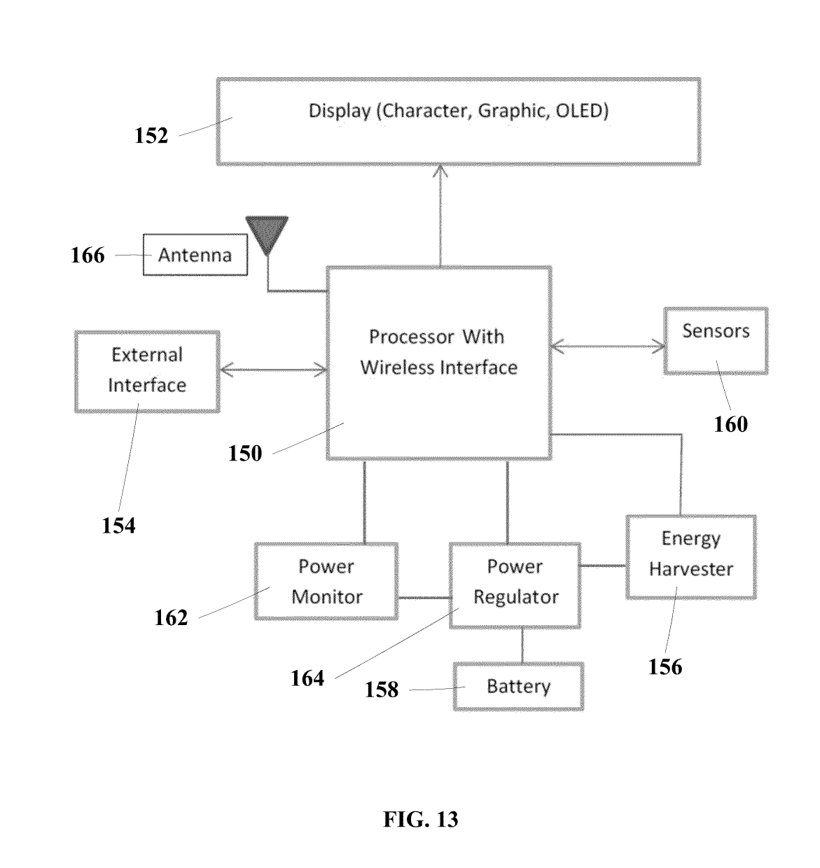

FIG. 13 depicts a box diagram of the components of a pair of jeans incorporated with electronic components in accordance with embodiments. The jeans may comprise a processor 150 with a wireless interface that may receive information from an electronic device 30, such as, but not limited to a cell phone and a tablet. The processor 150 may monitor sensor data transmitted via either a wired or wireless connection from sensors located on the jeans. The sensor data may allow the processor 150 to make decisions concerning what may be displayed on a display 152 on the jeans, how an external interface 154 is functioning, and/or how an energy harvester 156 is functioning. In embodiments, the processor 150 may monitor power usage and adjust display communication. In embodiments, the processor 150 may take analog measurements of the voltage being distributed among the electronic components in order to extend the battery life of a battery 158.

In embodiments, the jeans may further include a display 152 that may provide characters, graphics, etc. based on decisions made by the processor 150. The display 152 may receive instructions from the processor 150 in order to carry out the displaying of messages. In embodiments, the display 152 may exist on a pair of jeans in an area where a pocket may exist. A door element 110 may be stitched adjacent the display 152 in order to be able to cover the display 152. This embodiment may provide similar functionality as the embodiment including a door element 110, a Velcro loop layer 122, and a message tab 130. In embodiments, the display 152 may display at least one of OLED, TFT, E-Paper, and transflective, transmissive, or LED technology. In embodiments, the processor 150 may communicate with the display 152 via at least one of an SPI (Serial Peripheral Interface), an I2C (Inter-Integrated Circuit), and a parallel interface.

In embodiments, the jeans may further include sensors 160 that may be placed in various positions on the jeans. In embodiments, the sensors may include or exist as at least one of a 3-axis accelerometer, a gyro, a magnetometer, a temperature sensor, a humidity sensor, an ambient light sensor, a UV sensor, a proximity sensor, and a proximity sensor. The data received by the sensors 160 may be sent to the processor 150 in order for the processor 150 to make a determination concerning the functioning of one or more electronic components of the jeans.

In embodiments, the jeans may further include an external interface 154, such as, but not limited to a capacity touch interface, a membrane interface, and a gesture interface. The external interface 154 may allow a user to manually communicate with the display 152.

In embodiments, the jeans may further include a power monitor 162 and a power regulator 164. The power monitor 162 may monitor the voltage flowing to electronic components found on the jeans in order to make sure the proper voltage is being distributed properly to the electronic components. The power monitor may be connected to the power regulator 164 and may function in combination with the power regulator 164. The power regulator 164 may regulate the voltage flowing to components in order to provide the necessary voltage to the components. The power regulator 164 may be connected to a battery 158 and may regulate the voltage being excreted from the battery. In embodiments, the battery 158 may be rechargeable.

In embodiments, the jeans may further include an energy harvester 156 that may be connected to the processor. The energy harvester 156 may exist as at least one of a USB connection receiver, a wireless inductive charger, and a kinetic energy harvester. In embodiments, the energy harvester 156 may be affixed to an electrode that may receive an electric current from conductive fibers affixed to the electrode. In embodiments, the energy harvester may comprise an electrode and conductive fibers may be affixed to the electrode of the energy harvester.

In embodiments, the jeans may further comprise an antenna 166 connected to the processor 150. The processor 150 may be able to send and receive data wirelessly via the antenna 166. In embodiments, the processor 150 may be able to receive data from systems such as computing system 1.

In embodiments, a user electronic device 30 may be able to send and receive information to the processor 150 of the jeans via the antenna 166 of the jeans. Within an application on the user electronic device 30, a user may create a message or select a premade message to be displayed on the display 152 of the jeans. The user may, within the application, send the message to the processor 150 of the jeans via a wireless network and the antenna 166 of the jeans. The message may then be transmitted to the display 166 of the jeans.

The disclosure may provide a system. The system may comprise a pair of tubular legs extending from a tubular body portion. The system may further comprise a processor 150, at least one display 152 connected to the processor 150, at least one sensor 160 connected to the processor 150, an antenna 162 connected to the processor 150, an external interface 154 connected to the processor 150, a power monitor 162 coupled to the processor 150, a power regulator 164 coupled to the processor 150 and the power monitor 162, an energy harvester 156 coupled to the processor 150 and the power regulator 164, and a battery 158 coupled to the power regulator 164.

The system may further comprise at least one jean flap 102 comprising an interior surface and an exterior surface. The at least one jean flap 102 may reveal at least one of an orifice, the at least one display 152, and a message element backing 122 when the at least one jean flap 102 is in an open position. A first portion of the at least one jean flap 102 may be removably engageable with the at least one message element backing 122. A second portion of the at least one jean flap 102 may be hingedly affixed to at least one of the at least one message element backing 122, the pair of tubular legs, and the body portion.

In embodiments, the at least one display 152 may comprise at least one of LEDs and OLEDs.

In embodiments, the at least one jean flap 102 may be hingedly affixed to the at least one message element backing 122 via threading.

In embodiments, at least one of the processor 150, the at least one display 152, the at least one sensor 160, the antenna 162, the external interface 154, the power monitor 162, the power regulator 164, the energy harvester 156, and the battery 158 may comprise a nano-coating. In embodiments, the nano-coating may provide water repellency to an electronic component including the coating.

In embodiments, at least one of the processor 150, the at least one display 152, the at least one sensor 160, the antenna 162, the external interface 154, the power monitor 162, the power regulator 164, the energy harvester 156, and the battery 158 may be embedded within a seam of at least one of the pair of tubular legs and the body portion.

In embodiments, each of the at least one jean flap 102 may comprise a rivet.

In embodiments, each of the at least one jean flap 102 may comprise at least one accent.

In embodiments, the at least one accent may be rhinestones, glitter, fringed material, window grids, embossed sayings, embossed pictures, removably engageable sayings, removably engageable pictures, or combinations thereof.

In embodiments, the at least one jean flap 102 may comprise a rectangular geometry.

In embodiments, the at least one jean flap 102 may comprise a geometry other than a rectangular geometry.

In embodiments, at least one line of yarn may span a portion of the at least one orifice.

In embodiments, the at least one line of yarn may be at least one color.

In embodiments, the at least one jean flap 102 may comprise an interior reinforcement.

In embodiments, the interior reinforcement may be a thermoplastic, a thermoset plastic, an elastomer, a metal, a ceramic, silicone, a composite, or combinations thereof.

In embodiments, the interior reinforcement may be a thermoplastic. In embodiments, the interior reinforcement may be able to be reconfigured to a desired geometry when the thermoplastic is heated above a glass transition temperature of the thermoplastic.

In embodiments, the at least a first portion of each of the at least one jean flap 102 may be removably engageable via at least one hook portion of a Velcro hook and loop removably engageable to at least one loop portion of a Velcro hook and loop affixed to the at least one message backing element 122.

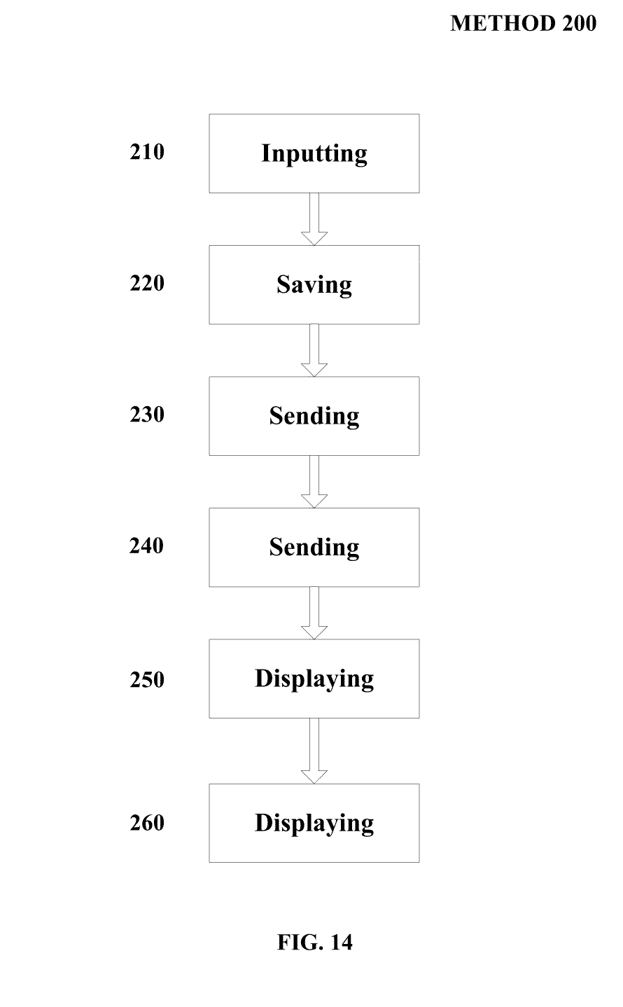

FIG. 14 displays a method 200 of displaying a message in accordance with embodiments. Method 200 may comprise inputting 210 via a user interface of an electronic device 30, a message. Method 200 may further comprise saving 220 the message as data on a memory of the electronic device 30. The method may further comprise sending 230, via a wireless network, the message to a processor 150 affixed to a pair of jeans. In embodiments, the pair of jeans may further comprise at least one jean flap 102 and at least one message element backing 122.

Method 200 may further comprise sending 240, via the processor 150, instructions to a display 152 affixed to the at least one message element backing 122 to display the message. Method 200 may further comprise displaying 250, via the display 152, the message.

In embodiments, the pair of jeans may further comprise a plurality of sensors.

In embodiments, at least one of the plurality of sensors 160 may be affixed to the at least one message element backing 122 and located adjacent the at least one jean flap 102.

In embodiments, at least one of the plurality of sensors 160 may comprise light detection capabilities.

In embodiments, method 200 may further comprise sending 260 commands, via the at least one of a plurality of sensors 160, to the at least one display 152 in response to a position of the at least one jean flap 102.

In embodiments, the jeans may comprise conductive fibers. The fibers may be intertwined within the yarns of the jeans and/or may exist as yarns themselves. In embodiments, the yarns may be made of polymer covered metal fibers.

The components of the jeans may exist in different sizes and shapes based on the size of jeans being produced.

It is appreciated that any of the mentioned elements, components, and/or functions may be incorporated into clothing for males. In regards to male clothing, elements, components, and/or functions may be adjusted accordingly.

For the purposes of this disclosure, the terms “door flap”, “door pocket”, “door element”, “engageable jean flap”, “engageable jean structure”, “flap”, and “jean flap” may be synonymous.

For the purposes of this disclosure, the terms “window”, “engageable window structure”, “engageable jean flap”, “flap”, and “jean flap” may be synonymous.

For the purposes of this disclosure, the terms “panel” and “saying panel” may be synonymous.

For the purposes of this disclosure, a message displayed on a display 152 and a message tab 130 may be alternatively described as a “message element”.

For the purposes of this disclosure, a display 152 and a Velcro loop layer 122 may be alternatively described as a “message element backing”.

The above features applied to jeans may, in other embodiments, be utilized on women's articles of clothing that may be worn on the upper or lower body of a woman such as, but not limited to, pants (other than women's jeans), tank tops, shirts, onezies, dresses, bikinis, lingerie, boxers, bras, panties, coats, jackets, flannels, hoodies, overalls, scarves, stockings, sweatshirts, tights, shorts, and sweaters.

1. A system comprising:
a pair of tubular legs extending from a tubular body portion;
a processor;
at least one display connected to the processor;
at least one sensor connected to the processor;
an antenna connected to the processor;
an external interface connected to the processor;
a power monitor coupled to the processor;
a power regulator coupled to the processor and the power monitor;
an energy harvester coupled to the processor and the power regulator;
a battery coupled to the power regulator;
at least one jean flap comprising an interior surface and an exterior surface, the at least one jean flap revealing at least one of an orifice, the at least one display, and a message element backing when the at least one jean flap is in an open position;
a first portion of the at least one jean flap removably engageable with the message element backing;
a second portion of the at least one jean flap hingedly affixed to at least one of the at least one message element backing, the pair of tubular legs, and the body portion.

2. The system of claim 1, the at least one display comprising at least one of LEDs and OLEDs.

3. The system of claim 1, the at least one jean flap hingedly affixed to the at least one message element backing via threading.

4. The system of claim 1, at least one of the processor, the at least one display, the at least one sensor, the antenna, the external interface, the power monitor, the power regulator, the energy harvester, and the battery comprising a nano-coating.

5. The system of claim 1, at least one of the processor, the at least one display, the at least one sensor, the antenna, the external interface, the power monitor, the power regulator, the energy harvester, and the battery embedded within a seam of at least one of the pair of tubular legs and the body portion.

6. The system of claim 1, the at least one jean flap comprising a rivet.

7. The system of claim 1, the at least one jean flap comprising at least one accent.

8. The system of claim 7, the at least one accent being rhinestones, glitter, fringed material, window grids, embossed sayings, embossed pictures, removably engageable sayings, removably engageable pictures, or combinations thereof.

9. The system of claim 1, the at least one jean flap comprising a rectangular geometry.

10. The system of claim 1, the at least one jean flap comprising a geometry other than a rectangular geometry.

11. The system of claim 1, at least one line of yarn spans a portion of the at least one orifice.

12. The system of claim 10, the at least one line of yarn being at least one color.

13. The system of claim 1, the at least one jean flap comprising an interior reinforcement.

14. The system of claim 12, the interior reinforcement being a thermoplastic, a thermoset plastic, an elastomer, a metal, a ceramic, silicone, a composite, or combinations thereof.

15. The system of claim 12, the interior reinforcement being a thermoplastic, the interior reinforcement able to be reconfigured to a desired geometry when the thermoplastic is heated above a glass transition temperature of the thermoplastic.

16. The system of claim 1, the first portion of the at least one jean flap removably engageable via at least one hook portion of a Velcro hook and loop removably engageable to at least one loop portion of a Velcro hook and loop affixed to the at least one message backing element.

17. A method of displaying a message comprising:
inputting, via a user interface of an electronic device, a message;
saving the message as data on a memory of the electronic device;
sending, via a wireless network, the message to a processor affixed to a pair of jeans, the pair of jeans further comprising at least one jean flap and at least one message element backing;
sending, via the processor, instructions to a display affixed to the at least one message element backing to display the message; and
displaying, via the display, the message.

18. The method of claim 17, the pair of jeans further comprising a plurality of sensors.

19. The method of claim 18, at least one of the plurality of sensors affixed to the at least one message element backing and located adjacent the at least one jean flap, the at least one of the plurality of sensors comprising light detection capabilities.

20. The method of claim 19, further comprising sending commands, via the at least one of a plurality of sensors, to the at least one display in response to a position of the at least one jean flap.
